(19) United States
(12) Patent Application Publication
(10) Pub. No.: US 2011/0201724 A1
(43) Pub. Date: Aug. 18, 2011

(54) Phosphorous-Containing Flame Retardant Epoxy Resin Composition, Prepreg and Laminate Thereof

(76) Inventors: Sergei V. Levchik, Croton-on-Hudson, NY (US); Fabienne Samyn, Arras (FR)

(21) Appl. No.: 13/125,180

(22) PCT Filed: Oct. 20, 2009
(86) PCT No.: PCT/US09/61276

§ 371 Date: Apr. 20, 2011

Related U.S. Application Data
(60) Provisional application No. 61/197,615, filed on Oct. 29, 2008.

(51) Int. Cl. C09D 163/00; C09K 21/14

(52) U.S. Cl. 523/400; 525/523

(57) ABSTRACT

There is provided herein a curable epoxy resin composition comprising at least one curable epoxy resin, at least one flame retardant curing agent, and at least one curing catalyst.

### FIELD OF THE INVENTION

This invention relates to flame retardant epoxy resin compositions, in particular curable flame retardant epoxy resin compositions comprising epoxy resin, polyarylene alkylphosphonate curing agent, and a quaternary phosphonium salt or quaternary ammonium salt curing catalyst. The curable flame retardant epoxy resin compositions shows wide processing window for reliable process of B-staging of prepregs.

### DETAILED DESCRIPTION OF THE RELATED ART

Flame retardant epoxy resins are used in a variety of electrical insulating materials due to the excellent self-extinguishing property, mechanical property, water-vapor resistance and electrical property. It is conventional in the preparation of epoxy-containing laminates to incorporate into the epoxy resin composition various additives to improve the flame-retardancy of the resulting laminate. Many types of flame retardant additives have been suggested, however, the additives which are most widely used commercially are halogen-containing additives, such as tetrabromobisphenol A, or epoxy resins prepared with tetrabromobisphenol A.

Although halogen-containing fire-retardant additives such as tetrabromodiphenylolpropane are effective, they are considered by some to be undesirable from an environmental standpoint, and in recent years there has been increasing interest in the formulation of halogen-free epoxy resins, which are able to meet the fire retardancy requirement which is typically V-0 in the standard “Underwriters Laboratory” test method UL 94.

There are some commercially available phosphorus-based fire retardant additives which may be useful for replacing halogen-containing fire-retardant additives. For example, by incorporating an addition-type phosphorus system flame-retardant such as triphenyl phosphate (TPP), tricresyl phosphate (TCP), cresyldiphenyl phosphate (CDP), resorcinol bis(diphenyl phosphate) (RDP), bisphenol A bis(diphenyl phosphate) (BDP) and the like which are a phosphate system compound, into an epoxy resin composition, the nonflammability can be maintained. Examples of such formulations are described, for example, in U.S. Pat. Nos. 5,919,844; 5,932,637; 6,348,523; 6,713,163 and European Patent Application 1,359,174. However, since general phosphorus compounds such as those described above do not react with an epoxy resin, other problems arise such as, solder heat resistance alter moisture absorption and the resistance to chemicals such as the alkali resistance and the like of molded articles are significantly reduced. Because of significant plasticizing effect of these phosphorus additives glass transition temperature (T_{g}) of the cured epoxy resin also finds significant drop.

Proposals have been made to use reactive phosphorus-based flame retardants instead of halogenated fire retardants in epoxy resin formulations. Overview of the state-of-the-art in phosphorus-based flame retardant epoxy resins was given in “Review on thermal decomposition, combustion and flame-retardancy of epoxy resins” by S. Levchik and E. Weil, Polymer International, Vol. 53, 2004, pp. 1901-1929. In some formulations phosphorus flame retardant was pre-reacted with an epoxy resin to form a di-or multifunctional epoxy resin which is then cured with a cross-linker.

The prior art describes the use of certain phosphorus element-containing compounds as crosslinking or curing agents for use with epoxy resins as a way to introduce a phosphorus element into epoxy resin systems. For example, U.S. Pat. Nos. 4,973,631; 5,086,156; 6,403,220; 6,740,732; 6,486,242; 6,733,698 and 6,887,950 describe the use of difunctional or trifunctional phosphine oxide crosslinkers as effective curing agents. The above-mentioned prior art compositions are not easily prepared and require exotic preparation procedures. It would be advantageous to provide a compound that can be derived from practical, industrial scale raw materials; and thus, would offer an economic advantage over the prior art processes.

However, the most often utilized phosphorus-based flame retardant for epoxy resins is 9,10-dihydro-9-oxa-10-phosphenanthrene 10-oxide (DOPO). There are commonly known two methods of applying DOPO to epoxy composites. In the first method DOPO is pre-reacted with epoxy resin as described in European Patent Application 0,806,429 and U.S. Pat. Nos. 6,645,631; 6,291,627 and 6,486,242. Because DOPO is a monofunctional reactive compound it terminates epoxy chains and therefore only multifunctional, usually more expensive than difunctional epoxies, must be used in this process. In the second method DOPO is pre-reacted with quinone or ketone type of compounds, having apart of these functionalities also two or more hydroxyl groups or amine groups as described, for example, in European Patent Applications 1,103,575 and 1,537,160 and U.S. Pat. Nos. 6,291,626; 6,441,067; 6,933,050; 6,534,601; 6,646,064; 6,762,251 and 6,984,716 and in PCT Patent Publication 05/118604. This method suffers by the complexity which results in expensive compounds with low phosphorus content in the molecules.

Alkyl and aryl phosphonates in general are compatible with epoxy resins. In particular lower alkyl phosphonates are of value because they contain a high proportion of phosphorus, and are thus able to impart good fire retardant properties upon resins in which they are incorporated. Examples of use of the phosphonates in epoxy resins are shown for example in U.S. Pat. Nos. 5,710,305 and 6,353,080. However, if phosphonates are used as additives they suffer similar problems as unreactive phosphates described above. The main problems with unreactive phosphonates are low glass transition temperature and high moisture absorption of epoxy compounds. The laminates containing high levels of moisture tend to blister and fail, when introduced to a bath of liquid solder at temperatures around 260° C. for lead-based solder or around 288° C. for lead-free solder, a typical step in the manufacture of printed wiring boards.

Use of hydroxyl-terminated poly(m-phenylene methylphosphonate) in epoxy systems was described in PCT Patent Publication 03/029258. Here the epoxy resin was cured by poly(m-phenylene methylphosphonate) in the presence of a methylimidazole as curing catalyst. Furthermore, this polyphosphonate effectively cures epoxy resin as described by T. Wu, A. M. Piotrowski, Q. Yao and S. V. Levchik in Journal of Applied Polymer Science, Vol. 101, pp. 4011-4022. Because the phosphonate is effectively incorporated in the epoxy network the final cured composite shows high glass transition temperature and low water absorption. PCT Patent Publication 04/060957 describes a process of pre-reaction of epoxy resin with poly(m-phenylene methylphosphonate), however because this polyphosphonate is a multifunctional compound it tends to cross-link epoxy resin and therefore pre-reaction cannot be effectively controlled on commercial scale.

Because phosphonate cures epoxy via insertion of the epoxy group into the phosphate ester group P—O—C, every single reaction results in branching in the polymer network. Furthermore, some common epoxy curing catalysts, like imidazoles or tertiary amines, catalyze self-curing of epoxy along with the insertion of epoxy into P—O—C. Therefore the gelation occurs in relatively narrow temperature interval. This limits the processing window for B-staging of prepregs, because at low temperature or in a short period the resin exhibits excessive flow, whereas at higher temperature and/or over a longer period the epoxy may excessively cross-link to limit resin flow.

It is well-known in the art to use quaternary ammonium salts, and phosphonium salts, more specifically quaternary ammonium halide, and phosphonium halides for reacting epoxides with compounds containing phenolic hydroxyls to produce high molecular weight epoxy compounds. See, for example: U.S. Pat. Nos. 2,216.099; 2,633,458; 2,658,855; 3,377,406; 3,477,990; 3,547,881; 3,547,885; 3,694,407; 3,738,862; 3,948,855; and 4,048,141 and European Patent No. 0,019,852 and Handbook of Epoxy Resins by H. Lee and K. Neville, McGraw-Hill (1967) and Chemistry and Technology of Epoxy Resins, Edited by B. Ellis, Blade Academic and Professional (1993). It is also described in U.S. Pat. No. 4,048,141 that certain phosphonium catalysts promote the reaction between vicinal epoxides and phenols, carboxylic acids or carboxylic anhydrides.

In a journal publication by S. Minegishi, S. Komatsu, A. Kameyama and T Nishikubo (J. Polym. Sci., Part A, Polym. Chem., 1999, Vol. 37, pp. 959-965) the use of tetrabutylammonium bromide, tetrabutylammonium chloride, tetrabutylphosphonium bromide and tetrabutylphosphonium chloride as catalysts to react diaryl phenyl phosphonate with epoxide is described. Reaction was carried out for long time (48 hours) and produced linear polyphosphonate. T. Wu, A. M. Piotrowski, Q. Yao and S. V. Levchik (J. Applied polymer Science, 2006, Vol. 101, pp. 4011-4022) studied reaction of epoxide with poly(m-phenylene methylphosphonate) by differential scanning calorimetry and found it slow and inappropriate for commercial epoxy curing cycle(s). 2-methyl imidazole was selected as more efficient catalyst.

In light of the limitation of the prior art, an object of the present invention is to provide curable flame retardant epoxy resin compositions for use in production of epoxy prepregs and epoxy laminates and in the manufacture of printed-wiring boards and multilayer printed-wiring boards, which possess wide processing window and therefore where prepregs can be easily B-staged. Furthermore, the laminate must show high thermal stability and good moisture resistance.

### SUMMARY OF THE INVENTION

The present invention provides a curable epoxy resin composition comprising at least one curable epoxy resin, at least one flame retardant curing agent such as polyarylene alkylphosphonate curing agent, and at least one curing catalyst such as quaternary phosphonium or quaternary ammonium salt curing catalyst.

The present invention relates to printed wiring boards, e.g., printed wiring boards for electronic applications, encapsulants for electronic elements, protective coatings, and structural and/or decorative composite materials that comprise the herein described curable flame retardant epoxy resin composition.

### DESCRIPTION OF THE PREFERRED EMBODIMENTS

The curable flame retardant epoxy resin composition of the present invention contains, as one essential component, at least one curable epoxy resin. This component can be a non-halogen containing epoxy resin, for example, monofunctional epoxies, aliphatic, cycloaliphatic, and aromatic monofunctional epoxy resins and includes such chemistries as cresyl glycidyl ether, benzyl glycidyl ether. Other useful epoxy resins of the present invention include, but are not limited, to difunctional, trifunctional, tetrafunctional, and higher functional epoxy resins. Examples of these types of epoxies include, but are not limited to diglycidyl ethers of bisphenol A, diglycidyl ethers of bisphenol F, diglycidyl ether of bisphenol S, diglycidyl-p-aminophenol, triglycidyl aminocresol, triglycidyl-p-aminophenol, tetraglycidyl ethers of methylenedianiline, phenol novolac type epoxy resins, cresol novolac type epoxy resins, resorcinol type epoxy resins, epoxy resins with a naphthalene skeleton, biphenyl type epoxy resins, dicyclopentadiene type epoxy resins and diphenylfluorene type epoxy resins, and the like. These resins can be used individually or in any appropriate combinations. Also, other useful epoxy resins or other resins of this general type that are useful in the present invention are those that have utility for the manufacture of printed wiring boards or other electronic substrate materials. As such, compatible mixtures of any of these resins may be employed, if desired.

This component, i.e., the curable epoxy resin, is present in an amount that ranges from about 50 to about 90 percent by weight of the total weight of the composition. More preferably, the curable epoxy resin is present in an amount that ranges from about 65 to about 90 percent by weight of the total weight of the composition.

The polyarylene alkylphosphonate curing agent is present at from about 5% to about 40%, by weight of the total weight of the composition, preferably from about 5% to about 25%, by weight. This flame retardant curing agent, as more fully described in PCT International Patent Publication No. WO 03/029258, which content is incorporated by reference herein in its entirety is an oligomeric phosphonate comprising the repeating unit —OP(O)(R)—O-Arylene- where R can be a linear or branched alkyl containing up to about 8 carbon atoms, preferably up to about 6 carbon atoms and which has a phosphorus content of greater than about 12%, by weight. The phosphonate species in the composition comprise those containing —OH end groups as well, possibly, those not containing —OH end groups. The preferred R group is methyl, but can be any lower alkyl. In one embodiment, the polyarylene alkylphosphonate curing agent is poly(m-phenylene methylphosphonate).

By “Arylene” is meant any radical of a dihydric phenol. The dihydric phenol preferably should have its two hydroxy groups in non-adjacent positions. Examples include the resorcinols; hydroquinones; and bisphenols, such as bisphenol A, bisphenol F, and 4,4′-biphenol, phenolphthalein, 4,4′-thiodiphenol, or 4,4′-sulfonyldiphenol. The Arylene group can be 1,3-phenylene, 1,4-phenylene, or a bisphenol diradical unit, but it is preferably 1,3-phenylene.

In one embodiment the curing catalyst is at least one described by the formula:

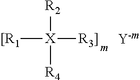

wherein each R₁, R₂, R₃ and R₄ independently is a hydrocarbyl or inertly substituted hydrocarbyl radical containing from 1 to about 12 carbon atoms, X is P or N, Y is an anion and m is the valence of the anion. In one embodiment the hydrocarbyl radical is a linear or branched alkyl group containing up to about 12 carbon atoms, which can be inertly substituted with O, N or S. These compounds may be alternatively described as tetrahydrocarbyl phosphonium or tetrahydrocarbyl ammonium salts. These catalysts are surprisingly effective in selectively catalyzing the desired reaction of insertion of epoxy group into P—O—C bond at a suitable reaction rate. In one embodiment Y is an anion selected from the group consisting of bromide, chloride, iodide, acetate, acetate complex, acetate/acetic acid complex, phosphate, phosphate complex and hydroxide. In one embodiment m can be 1, 2 or 3.

Preferred catalysts are, but not limited to, quaternary phosphonium and ammonium salts. The quaternary phosphonium salts include, for example, tetrabutylphosphonium chloride, tetrabutylphosphonium bromide, tetrabutylphosphonium iodide, tetrabutylphosphonium acetate complex, tetraphenylphosphonium chloride, tetraphenylphosphonium bromide, tetraphenylphosphonium iodide, ethyltriphenylphosphonium chloride, ethyltriphenylphosphonium bromide, ethyltriphenylphosphonium iodide, ethyltriphenylphosphonium acetate complex, ethyltriphenylphosphonium phosphate complex, propyltriphenylphosphonium chloride, propyltriphenylphosphonium bromide, propyltriphenylphosphonium iodide, butyltriphenylphosphonium chloride, butyltriphenylphosphonium bromide, butyltriphenylphosphonium iodide, ethyltri-p-tolylphosphonium acetate/acetic acid complex, ethyltriphenylphosphonium acetate/acetic acid complex or combinations thereof and the like as are described in U.S. Pat. Nos. 5,208,317, 5,109,099 and 4,981,926, the contents of each of which are incorporated herein by reference in their entirety. Most preferred catalysts include tetraethylammonium bromide, tetraethylammonium hydroxide, ethyltritolylphosphonium acetate and ethyltriphenylphosphonium acetate.

The quaternary ammonium salts include, for example, tetramethylammonium chloride, tetramethylammonium bromide, tetramethylammonium iodide, triethylbenzylammonium chloride, triethylbenzylammonium bromide, triethylbenzylammonium iodide, tetraethylammonium chloride, tetraethylammonium bromide, tetraethylammonium iodide, tetraethylammonium hydroxide, tetra(n-butyl)ammonium chloride, tetra(n-butyl)ammonium bromide, tetra(n-butyl)ammonium iodide, tetra(n-butyl)ammonium hydroxide, tetra (n-octyl)ammonium chloride, tetra(n-octyl)ammonium bromide, tetra(n-octyl)ammonium iodide, tetra(n-octyl)ammonium hydroxide, methyltris(n-octyl)ammonium chloride, bis(tetraphenylphosphoranylidene) ammonium chloride, etc.

The amount of catalyst used depends on the molecular weight of the catalyst, the activity of the catalyst and the speed at which the polymerization is intended to proceed. In general, the catalyst is used in an amount of from 0.01 parts per 100 parts of resin (p.h.r.) to about 1.0 p.h.r., more preferably, from about 0.01 p.h.r. to about 0.5 p.h.r. and, most preferably, from about 0.1 p.h.r. to about 0.5 p.h.r. In one embodiment herein it will be understood herein that parts of resin relates to the parts of curable epoxy resin described herein.

The epoxy resin composition of the present invention can contain optional additives, for example, auxiliary flame retardant additives, as well as, the following types of materials: fiber and/or cloth reinforcing additives; mineral fillers, such as Al(OH)₃, Mg(OH)₂ or silica; release agents; colorants; and the like.

In one embodiment herein the epoxy resin composition can be used in other applications, e.g., electronic applications, such as prepegs, printed wiring boards, encapsulants for electronic elements, protective coatings, structural and/or decorative composite materials in amounts as deemed necessary depending on the particular application but in one non-limiting preferable embodiment can be used in amounts of from about 0.01 p.h.r. to about 2.0 p.h.r., more preferably from about 0.01 p.h.r. to about 0.5 p.h.r. and most preferably from about 0.1 p.h.r. to about 0.5 p.h.r.

The present invention is further illustrated by the Examples that follow:

### EXAMPLES

### Materials

Epoxy 1, (PNE) phenol novolac epoxy, D.E.N. 438, brand of Dow Chemicals
Epoxy 2, (CNE) creosol novolac epoxy, EPON 164, brand of Hexion
Curing Agent, (PMP) poly(m-phenylene methylphosphonate), Fyrol PMP, brand of ICL-IP
Catalyst 1: (ETPPA) ethyl triphenyl phosphonium acetate (70% solution in methanol), purchased from Alfa Aesar
Catalyst 2: (ETPPB) ethyl triphenyl phosphonium bromide, product of Dishman Co.,
Catalyst 3: (2-MI) 2-methylimidazole, Amicure AMI-2, brand of Air Products
Catalyst 4: (2-PD 2-phenylimidazole, Amicure PI-2, brand of Air Products
Catalyst 5: (DMAPM) bis(dimethylaminopropyl)methylamine, Polycat 77, brand of Air Products
Catalyst 6: (DMAMP)<90% tris-2,4,6-(dimethylaminomethyl)phenol+<10% bis(dimethylaminomethyl)phenol, Ancamide K54, brand of Air Products
Solvent: methylethyl ketone, (MEK), purchased from Fluka
Glass cloth: 7628/50 style, product of BGF Industries

### Copper Foil Gould Electronics Inc., (JTC, 1.0 oz./ft.²)

Preparation of the Varnish.

Weighted amount of epoxy resin(s) and Fyrol PMP were preheated in separate jars to the temperature of 100-120°. The resins and Fyrol PMP were poured into a 3 neck round bottom flask equipped with a mechanical stirrer, a thermometer and a heating mantle. Then 25 p.h.r. of MEK was added at continuous stirring until a clear uniform solution was obtained. The viscosity of solution was adjusted to 700-1000 cPa 25° C.) by further addition of MEK. The catalyst was dissolved separately in MEK or acetone and added to the varnish last in the amount of 0.15-1.0 p.h.r.

Manufacturing of Prepreg

The glass cloth (10.5×10.5 inch) was manually brushed on the sides with varnish at room temperature. The glass cloth was placed in a preheated air circulated oven at 175-185° C. and exposed to the heat for a certain period of time. Experiments were repeated with different exposure times. Prepregs with resin content of about 40% were manufactured.

Resin Flow Measurement

The obtained prepregs were tested for resin flow according to IPC-TM-650 test 2.3.16.2. The resin flow was plotted as a function of exposure time which normally resulted in linear graphs with a negative slope. The calculated slope represents the characteristic of the processing window. The slopes from −0.1 to −0.5 represent a wide processing window, whereas the slopes from −0.7 to −1.5 represent a narrow processing window.

Manufacturing of Laminate

The stack of 8 prepregs with a copper foil in the bottom and on the top was placed between two stainless steel plates. Four sheets of Kraft paper were placed below and above the plates. The entire assembly was placed in a hydraulic press which was linearly heated to 185 or 200° C. Pressure of 200 psi was applied at 170° C. Laminates were cured at isothermal (185° C. or 200° C.) heating for 90 minutes followed by postcuring at 215° C. or 230° C. respectively for 15 minutes.

Pressure Cooker Test

The copper was etched from laminates according to IPC-TM-650, test 2.3.7.1. The pressure cooker test (PCT) was performed according to IPC-TM 650, test 2.6.16 with the following modifications: (a) specimens were exposed to the steam in autoclave for 1, 2 and 4 hours; (b) temperature of solder bath was held at 288° C., (c) specimens were dipped in the solder for 5 minutes.

Glass Transition Temperature (T_{g})

Glass transition temperature was measured by Differential Scanning Calorimetry (DSC) according to IPC-TM 650, test 2.4.25

Thermal Stability

Thermal stability of laminates was measured by Thermogravimetric analysis (TGA) at a heating rate of 10° C./minute in inert atmosphere of nitrogen. 5 percent wt. loss was recorded as T_{d}.

TABLE 1
Table 1 below composition of the varnish physical properties of prepregs
and physical properties of laminates

| | Inventive | | | | | Comparative | | | | |
|---|---|---|---|---|---|---|---|---|---|---|
| | Ex. 1 | Ex. 2 | Ex. 3 | Ex. 4 | Ex. 5 | Ex. 6 | Ex. 7 | Ex. 8 | Ex. 9 | Ex. 10 |
| Epoxy 1, wt. % | 75 | 75 | 38 | 37.5 | 37.5 | 100 | 100 | 100 | 100 | 100 |
| Epoxy 2, wt. % | | | 38 | 37.5 | 37.5 | | | | | |
| Fyrol PMP | 25 | 25 | 24 | 25 | 25 | 25 | 25 | 25 | 25 | 25 |
| Catalyst | Cat. 1 | Cat. 1 | Cat. 1 | Cat. 1 | Cat. 2 | Cat. 3 | Cat. 3 | Cat.4 | Cat. 5 | Cat. 6 |
| Catalyst, p.h.r. | 0.35 | 0.35 | 0.35 | 0.35 | 0.35 | 0.15 | 0.30 | 0.3 | 1.0 | 1.0 |
| Prepreg | | | | | | | | | | |
| B-staging, ° C. | 180 | 180 | 180 | 180 | 185 | 180 | 180 | 180 | 180 | 190 |
| Resin flow^{a} | −0.5 | −0.5 | −0.3 | −0.3 | −0.3 | −0.3 | −0.9 | −0.9 | −1.2 | −1.4 |
| Laminate | | | | | | | | | | |
| Cure cycle, | 185° C., 90 | 200° C., 90 | 200° C., 90 | 200° C., 90 | 200° C., 90 | 185° C., 90 | | | | |
| T ° C./minutes | 215° C., 15 | 230° C., 15 | 230° C., 15 | 230° C., 15 | 230° C., 15 | 215° C., 15 | | | | |
| Color | yellow | yellow | yellow | yellow | yellow | brownish | br. | br. | br. | br. |
| PCT, 1 h | pass | pass | — | — | — | pass | | | | |
| PCT, 2 h | fail | pass | pass | — | pass | fail | | | | |
| PCT, 4 h | — | fail | pass | pass | fail | — | | | | |
| T_{g}, (DSC), ° C. | 145 | 147 | 160 | 169 | 160 | 135 | | | | |
| T_{d}, 5 wt. % loss | 378 | 371 | 367 | 367 | 367 | 365 | | | | |

^{a}Slope of the plot of resin flow versus B-staging time determines processing window

As it is seen from Table 1 catalysts 4, 5 and 6 gave very narrow processing windows for B-staging of the prepreg, therefore they were not applied for manufacturing of the laminate. Catalyst 3, although giving an acceptable processing window at 0.15 p.h.r. showed poor properties of the laminate. An increase of concentration of catalyst 3 to 0.3 p.h.r. resulted in narrowing of the processing window. Catalysts 3, 4, 5, 6 also resulted in intensely brownish colored laminates which may impair quality inspection of the laminates.

Other embodiments of the invention will be apparent to those skilled in the art from a consideration of this specification or practice of the invention disclosed herein. It is intended that the specification and examples be considered as exemplary only, with the true scope and spirit of the invention being defined by the following claims.

1. A curable epoxy resin composition comprising at least one curable epoxy resin, at least one flame retardant curing agent, and at least one curing catalyst.

2. The curable epoxy resin composition of claim 1, wherein the flame retardant curing agent is a polyarylene alkylphosphonate.

3. The curable epoxy resin composition of claim 1, wherein the flame retardant curing agent is poly(m-phenylene methylphosphonate).

4. The curable epoxy resin composition of claim 1 wherein the curable epoxy resin is present in an amount that ranges from about 50 to about 90 percent by weight of the total weight of the curable epoxy resin composition.

5. The curable epoxy resin composition of claim 1 wherein the curable epoxy resin is present in an amount that ranges from about 65 to about 90 percent by weight of the total weight of the curable epoxy resin composition.

6. The curable epoxy resin composition of claim 2 wherein the polyarylene alkylphosphonate is present in an amount that ranges from 5 to about 40 percent by weight of the total weight of the composition.

7. The curable epoxy resin composition of claim 1 wherein the at least one catalyst is described by the formula: 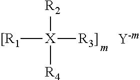
wherein each R₁, R₂, R₃ and R₄ independently is a hydrocarbyl or inertly substituted hydrocarbyl radical, X is P or N, Y is an anion and m is the valence of the anion.

8. The curable epoxy resin composition of claim 1 wherein the catalyst is ammonium quaternary salt or phosphonium quaternary salt.

9. The curable epoxy resin composition of claim 1 wherein the catalyst is present in an amount from about 0.01 to about 1.0 parts per 100 parts of curable epoxy resin.

10. A prepeg comprising the composition of claim 1.

11. A laminate comprising the composition of claim 1.

12. An encapsulant for printed wiring boards comprising the composition of claim 1.

13. A protective coating comprising the composition of claim 1

14. A structural and/or decorative composite material comprising the composition of claim 1.
